(19) United States
(12) Patent Application Publication
(10) Pub. No.: US 2008/0214247 A1
(43) Pub. Date: Sep. 4, 2008

(54) Communication method and communication system

(75) Inventor: Tsung-Cheng Yang, Taipei (TW)

Correspondence Address: BIRCH STEWART KOLASCH & BIRCH, PO BOX 747, FALLS CHURCH, VA, 22040-0747, US

(73) Assignee: INVENTEC CORPORATION

(21) Appl. No.: 11/712,390

(22) Filed: Mar. 1, 2007

(51) Int. Cl. H04M 1/00

(52) U.S. Cl. 455/569.2

(57) ABSTRACT

A communication method includes the following steps. First, a cell phone is connected to an earphone in a wireless manner. Next, the cell phone is enabled to be chosen to enter a wireless intercom mode. Then, a voice control module of the cell phone is enabled to receive a first voice signal outputted from a first microphone module of the cell phone and transfer the first voice signal to the earphone, such that a second headset module of the earphone is enabled to output the first voice signal. Finally, the voice control module of the cell phone is enabled to receive a second voice signal outputted from a second microphone module of the earphone and to transfer the second voice signal to the cell phone, such that a first headset module of the cell phone is enabled to output the second voice signal.

### BACKGROUND OF THE INVENTION

1. Field of Invention

The invention relates to a communication method and a communication system, and, in particular, to a method and a system for communicating a cell phone with an earphone.

2. Related Art

Referring to FIG. 1, a conventional communication system 1 has a first cell phone 20 and a second cell phone 30. The first cell phone 20 has a microphone module 21 and a headset module 22, and the second cell phone 30 has a microphone module 31 and a headset module 32.

When a user carrying the first cell phone 20 wants to communicate with another user carrying the second cell phone 30, the microphone module 21 of the first cell phone 20 can output a voice signal S7, which is transferred to the second cell phone 30 through a communication network W. Thus, the voice signal S7 can be outputted from the headset module 32 of the second cell phone 30. Similarly, the microphone module 31 of the second cell phone 30 may output a voice signal S8, which is transferred to the headset module 22 of the first cell phone 20 for output through the communication network W.

However, when either the first cell phone 20 or the second cell phone 30 is connected to the communication network W, the connection fee must be paid, and the connection fee becomes higher as the connection time is longer. So, the user has a great load.

In addition, the current cell phone has the developed wireless communication function. Referring to FIG. 2, the first cell phone 20 further has a voice control module 23, and the second cell phone 30 further has a voice control module 33. When the microphone module 21 of the first cell phone 20 outputs a voice signal S9, the voice control module 23 of the first cell phone 20 transfers the voice signal S9 to the voice control module 33 of the second cell phone 30, and the voice control module 33 can transfer the voice signal S9 to the headset module 32 of the second cell phone 30. Similarly, when the microphone module 31 of the second cell phone 30 outputs a voice signal S10, the voice control module 33 of the second cell phone 30 transfers the voice signal S11 to the voice control module 23 of the first cell phone 20, and the voice control module 23 transfers the voice signal S10 to the headset module 22 of the first cell phone 20 for output.

Thus, the users can communicate with each other without using the communication network that has to be paid when the voice control modules 23 and 33 of the first cell phone 20 and the second cell phone 30 are transferring or receiving the voice signals S9 and S10. However, the cell phones 20 and 30 having the voice control modules 23 and 33 are not popularized. When one user does not carry the cell phone or when one cell phone does hot have the voice control module, the users cannot communicate with each other smoothly.

Thus, it is an important subject to provide a communication system and a communication method capable of saving the communicating cost and simplifying the communication way.

### SUMMARY OF THE INVENTION

In view of the foregoing, the invention is to provide a communication method and a communication system capable of advantageously saving the communication cost and simplifying the communication manner.

To achieve the above, the invention discloses a communication method including the following steps. First, a cell phone is connected to an earphone in a wireless manner. Next, the cell phone is enabled to be chosen to enter a wireless intercom mode. Then, a voice control module of the cell phone is enabled to receive a first voice signal outputted from a first microphone module of the cell phone and transfer the first voice signal to the earphone, such that a second headset module of the earphone is enabled to output the first voice signal. Finally, the voice control module of the cell phone is enabled to receive a second voice signal outputted from a second microphone module of the earphone and to transfer the second voice signal to the cell phone, such that a first headset module of the cell phone is enabled to output the second voice signal.

To achieve the above, the invention also discloses a communication system including a cell phone and an earphone. The cell phone has a voice control module, a first microphone module and a first headset module. The voice control module receives a first voice signal outputted from the first microphone module. The earphone is connected to the cell phone in a wireless manner and has a second microphone module and a second headset module. The voice control module of the cell phone transfers the first voice signal to the earphone, and the second headset module outputs the first voice signal. The second microphone module outputs a second voice signal. The voice control module of the cell phone receives the second voice signal and the first headset module of the cell phone outputs the second voice signal.

As mentioned above, the voice control module of the cell phone can transfer and receive the voice signal between the cell phone and the earphone so that two users may talk to each other using the cell phone and the earphone in the communication method and the communication system according to the invention. Compared with the prior art, the fee for connecting to the communication network can be saved when the communication method and system of the invention are utilized. In addition, the cell phone can be directly connected to the earphone in the communication method and system of the invention. Compared with the prior art, in which the cell phone only can be connected to another cell phone under some limitations, the invention indeed brings the convenience for the user. In addition, the cell phone further has a hands-free module, and the user can use the hands-free module to communicate with the earphone through the wireless communication. Alternatively, the cell phone further has a communication module, and the user can use the communication module to communicate with another cell phone. Thus, the communication method and system of the invention provide the diversified communication manners to be chosen by the user to satisfy his or her requirement.

### BRIEF DESCRIPTION OF THE DRAWINGS

The invention will become more fully understood from the detailed description given herein below illustration only, and thus is not limitative of the present invention, and wherein:

FIG. 1 is a schematic illustration showing a conventional communication system;

FIG. 2 is a schematic illustration showing another conventional communication system;

FIG. 3 is a schematic illustration showing a communication system according to a preferred embodiment of the invention;

FIG. 4 is another schematic illustration showing the communication system according to the preferred embodiment of the invention;

FIG. 5 is a flow chart showing a communication method according to the preferred embodiment of the invention;

FIG. 6 is another flow chart showing the communication method according to the preferred embodiment of the invention; and

FIG. 7 is still another flow chart showing the communication method according to the preferred embodiment of the invention.

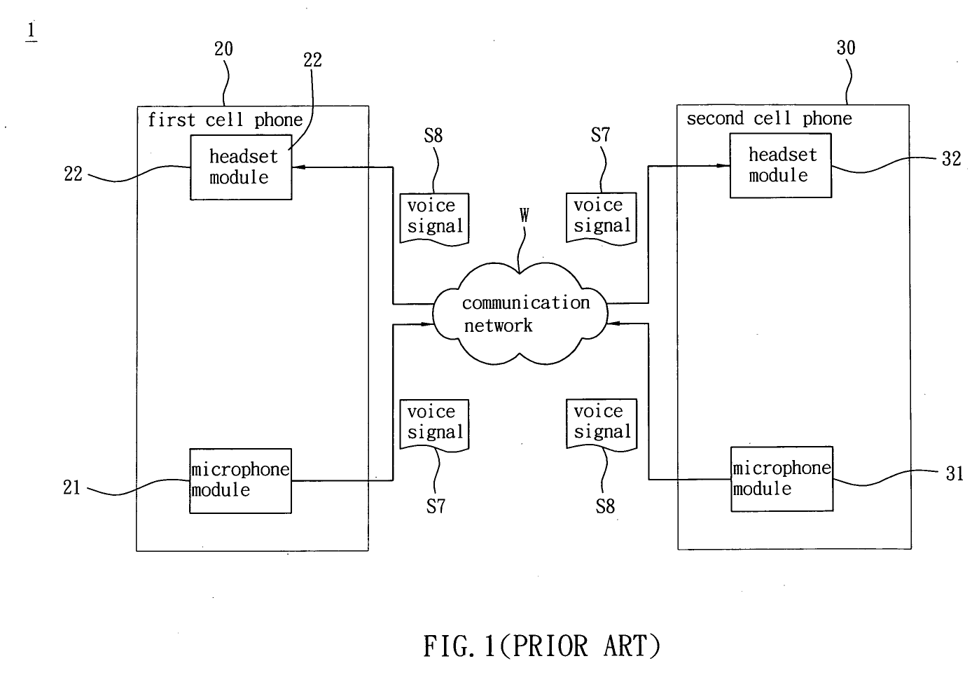

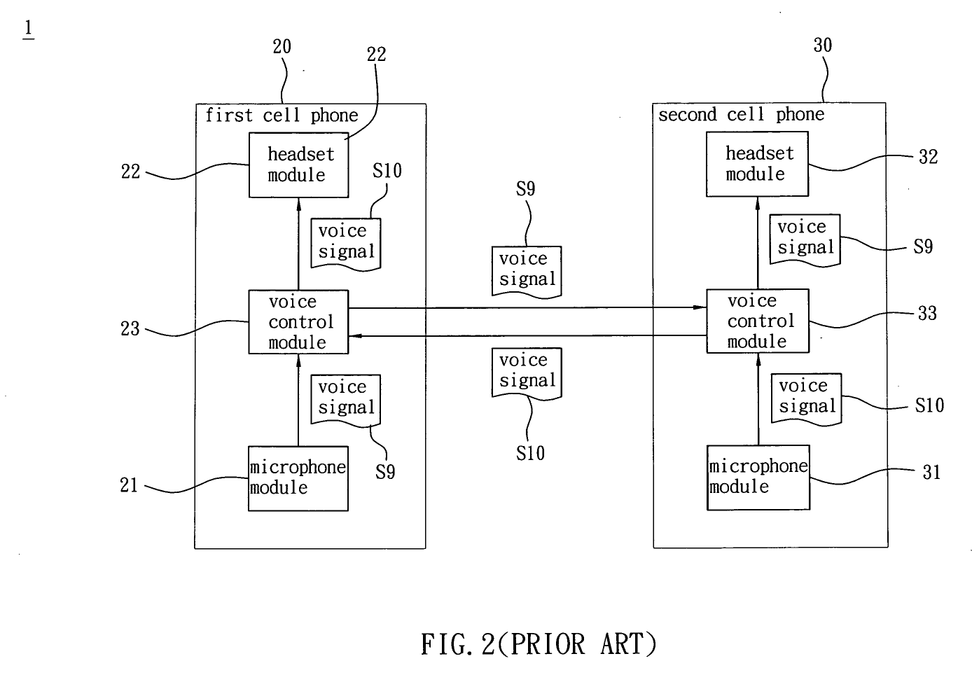

### DETAILED DESCRIPTION OF THE INVENTION

The present invention will be apparent from the following detailed description, which proceeds with reference to the accompanying drawings, wherein the same references relate to the same elements.

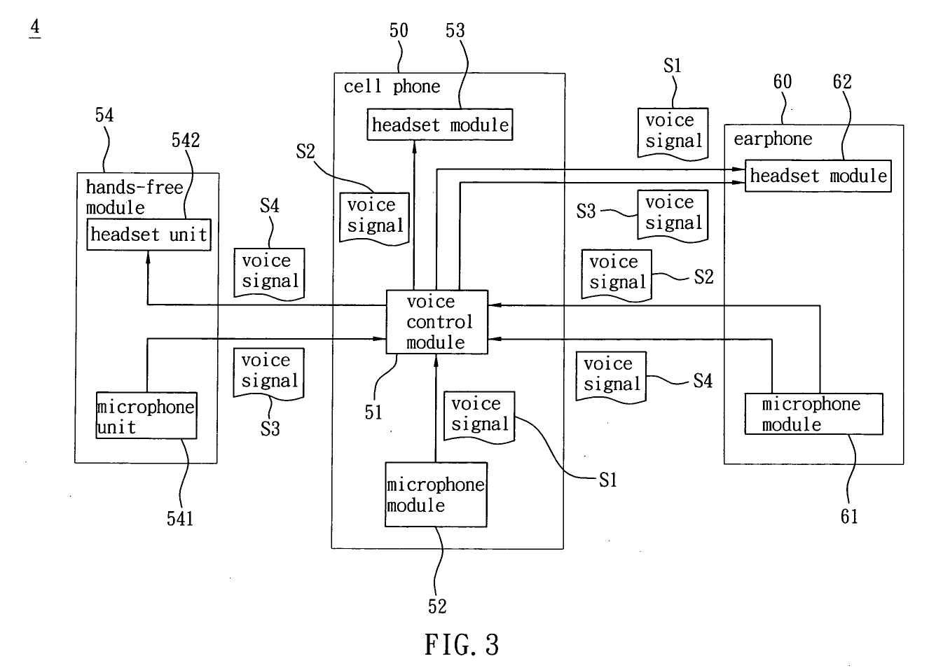

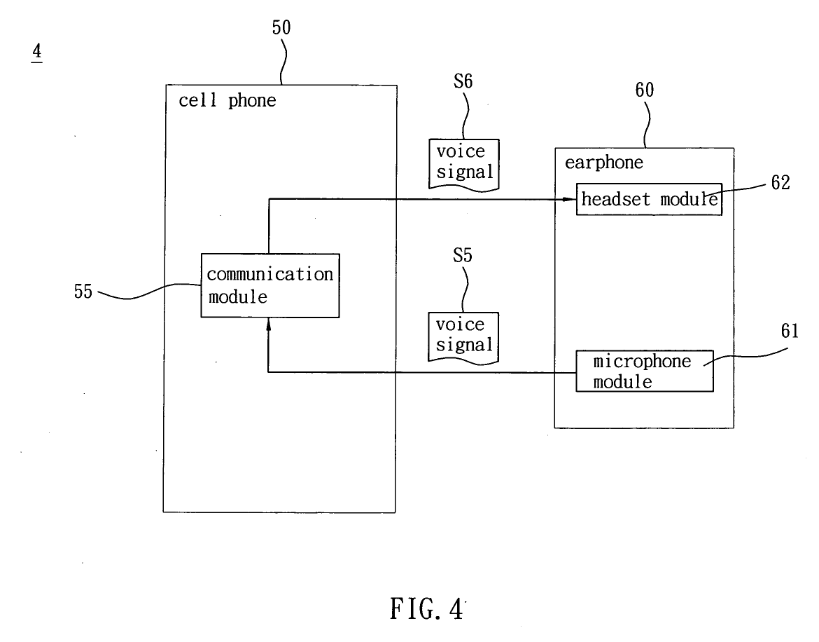

First, a communication system 4 according to the preferred embodiment of the invention will be described with reference to FIGS. 3 and 4. In this embodiment, the communication system 4 includes a cell phone 50 and an earphone 60.

Referring to FIG. 3, the cell phone 50 has a voice control module 51, a microphone module 52 and a headset module 53. In this embodiment, the cell phone 50 may be chosen to enter a wireless intercom mode. In addition, the microphone module 52 and the headset module 53 are connected to a circuit board (not shown) through a flexible circuit board (not shown), and the voice control module 51 is directly connected to the circuit board. Thus, the voice control module 51 can be electrically connected to the microphone module 52 and the headset module 53.

As shown in FIG. 3, the earphone 60 is connected to the cell phone 50 in a wireless manner, and the earphone 60 has a microphone module 61 and a headset module 62. In this embodiment, the earphone 60 is a bluetooth wireless earphone, and the earphone 60 and the cell phone 50 are connected to each other in a bluetooth transmission manner. Of course, the wireless manner between the earphone 60 and the cell phone 50 may also be an infrared transmission manner, a wireless network transmission manner or a wireless transmission manner.

Referring again to FIG. 3, the cell phone 50 further has a hands-free module 54, which has a microphone unit 541 and a headset unit 542. In this embodiment, the hands-free module 54 is a wired hands-free module.

Referring to FIG. 4, the cell phone 50 of this embodiment further has a communication module 55. When the cell phone 50 enters a wireless communication mode, the earphone 60 may communicate with another cell phone 50 through the communication module 55.

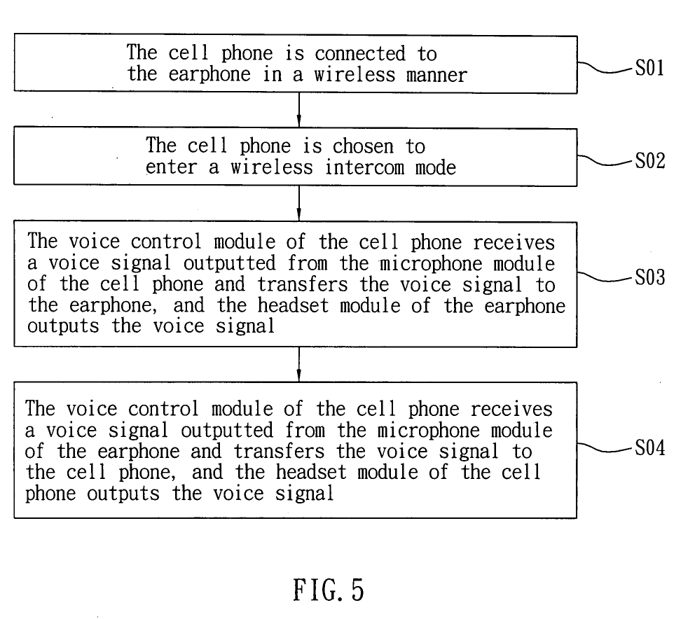

FIG. 5 is a flow chart showing a communication method according to the preferred embodiment of the invention. The steps of communicating the cell phone 50 with the earphone 60 when the cell phone 50 enters the wireless intercom mode will be described with reference to FIG. 5.

Referring to FIGS. 5 and 3, step S01 connects the cell phone 50 to the earphone 60 in a wireless manner. In this embodiment, the wireless manner is a bluetooth transmission manner. Of course, the wireless manner may also be an infrared transmission manner, a wireless network transmission manner or a wireless transmission manner.

In step S02, the cell phone 50 is chosen to enter a wireless intercom mode. A first user can utilize an operation interface (not shown) of the cell phone 50 to choose to enter the wireless intercom mode.

In step S03, the voice control module 51 of the cell phone 50 receives a voice signal S1 outputted from the microphone module 52 of the cell phone 50 and transfers the voice signal S1 to the earphone 60, and the headset module 62 of the earphone 60 outputs the voice signal S1. Thus, a second user can receive the voice through the second headset module 62 of the earphone 60 when the first user is outputting the voice to the first microphone module 52 of the cell phone 50.

In step S04, the voice control module 51 of the cell phone 50 receives a voice signal S2 outputted from the microphone module 61 of the earphone 60 and transfers the voice signal S2 to the cell phone 50, and the headset module 53 of the cell phone 50 outputs the voice signal S2. Thus, the first user can receive the voice through the headset module 53 of the cell phone 50 when the second user is outputting the voice to the microphone module 61 of the earphone 60.

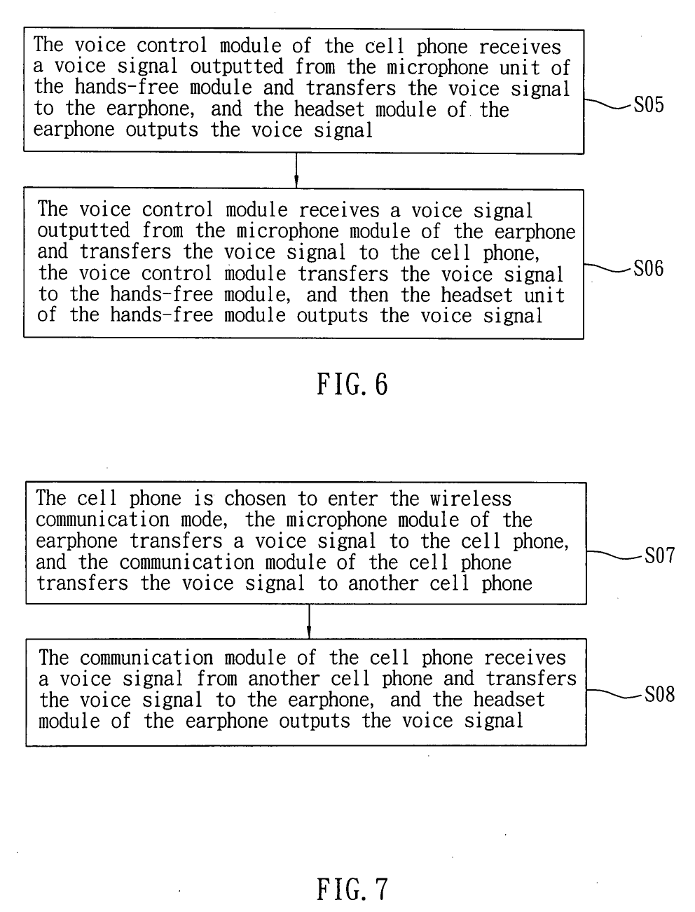

FIG. 6 is another flow chart showing the communication method according to the preferred embodiment of the invention. The steps of communicating the hands-free module 54 of the cell phone 50 with the earphone 60 when the cell phone 50 is chosen to enter the wireless intercom mode will be described with reference to FIG. 6.

Referring to FIGS. 6 and 3, in step S05, the voice control module 51 of the cell phone 50 receives a voice signal S3 outputted from the microphone unit 541 of the hands-free module 54 and transfers the voice signal S3 to the earphone 60. Then, the headset module 62 of the earphone 60 outputs the voice signal S3. Thus, the second user can receive the voice through the headset module 62 of the earphone 60 when the first user is outputting the voice to the microphone unit 541 of the hands-free module 54.

Referring to FIG. 6 in view of FIG. 3, in step S06, the voice control module 51 receives a voice signal S4 outputted from the microphone module 61 of the earphone 60 and transfers the voice signal S4 to the cell phone 50. The voice control module 51 transfers the voice signal S4 to the hands-free module 54, and then the headset unit 542 of the hands-free module 54 outputs the voice signal S4. Thus, the first user can receive the voice through the headset unit 542 of the hands-free module 54 when the second user is outputting the voice to the microphone module 61 of the earphone 60.

FIG. 7 is still another flow chart showing the communication method according to the preferred embodiment of the invention. The steps of communicating the earphone 60 with another cell phone (not shown) through the cell phone 50 when the cell phone 50 is chosen to enter the wireless intercom mode will be described with reference to FIG. 7.

As shown in FIGS. 7 and 4, in step S07, the cell phone 50 is chosen to enter the wireless communication mode, the microphone module 61 of the earphone 60 transfers a voice signal S5 to the cell phone 50, and the communication module 55 of the cell phone 50 transfers the voice signal S5 to another cell phone. Thus, the user can directly output his or her voice to the worn earphone 60, and transfer the voice to a communication network (not shown) through the communication module 55 so that another user can receive the voice through another cell phone.

In step S08, the communication module 55 of the cell phone 50 receives a voice signal S6 from another cell phone and transfers the voice signal S6 to the earphone 60, and the headset module 62 of the earphone 60 outputs the voice signal S6. Thus, the voice outputted from another user to another cell phone may also be transferred to the cell phone 50 through the communication network, and the communication module 55 of the cell phone 50 transfers the voice to the earphone 60 so that the user can receive the voice.

In summary, the voice control module of the cell phone can transfer and receive the voice signal between the cell phone and the earphone so that two users may talk to each other using the cell phone and the earphone in the communication method and the communication system according to the invention. Compared with the prior art, the fee for connecting to the communication network can be saved when the communication method and system of the invention are utilized. In addition, the cell phone can be directly connected to the earphone in the communication method and system of the invention. Compared with the prior art, in which the cell phone only can be connected to another cell phone under some limitations, the invention indeed brings the convenience for the user. In addition, the cell phone further has a hands-free module, and the user can use the hands-free module to communicate with the earphone through the wireless communication. Alternatively, the cell, phone further has a communication module, and the user can use the communication module to communicate with another cell phone. Thus, the communication method and system of the invention provide the diversified communication manners to be chosen by the user to satisfy his or her requirement.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A communication method, comprising:
connecting a cell phone to an earphone in a wireless manner;
enabling the cell phone to be chosen to enter a wireless intercom mode;
enabling a voice control module of the cell phone to receive a first voice signal outputted from a first microphone module of the cell phone, and to transfer the first voice signal to the earphone, wherein the first voice signal is outputted through a second headset module of the earphone; and
enabling the voice control module of the cell phone to receive a second voice signal outputted from a second microphone module of the earphone, and to transfer the second voice signal to the cell phone, wherein the second voice signal is outputted through a first headset module of the cell phone.

2. The method according to claim 1, wherein the cell phone has a hands-free module.

3. The method according to claim 2, wherein the voice control module receives a third voice signal outputted from a microphone unit of the hands-free module, and transfers the third voice signal to the earphone, and then the second headset module of the earphone outputs the third voice signal.

4. The method according to claim 2, wherein the voice control module receives a fourth voice signal outputted from the second microphone module of the earphone, and transfers the fourth voice signal to the cell phone, the voice control module transfers the fourth voice signal to the hands-free module, and a headset unit of the hands-free module outputs the fourth voice signal.

5. The method according to claim 1, wherein the wireless manner is a bluetooth transmission manner, an infrared transmission manner, a wireless network transmission manner or a wireless transmission manner.

6. The method according to claim 1, wherein the cell phone is chosen to enter a wireless communication mode, the second microphone module of the earphone transfers a fifth voice signal to the cell phone, and a communication module of the cell phone transfers the fifth voice signal to another cell phone.

7. The method according to claim 1, wherein the cell phone is chosen to enter a wireless communication mode, a communication module of the cell phone receives a sixth voice signal from another cell phone, and transfers the sixth voice signal to the earphone, and then the second headset module of the earphone outputs the sixth voice signal.

8. A communication system, comprising:
a cell phone having a voice control module, a first microphone module and a first headset module, wherein the voice control module receives a first voice signal outputted from the first microphone module and the cell phone may be chosen to enter a wireless intercom mode; and
an earphone, which is connected to the cell phone in a wireless manner and has a second microphone module and a second headset module, wherein when the cell phone is chosen to enter the wireless intercom mode, the voice control module of the cell phone transfers the first voice signal to the earphone, the second headset module outputs the first voice signal, the second microphone module outputs a second voice signal, and the voice control module of the cell phone receives the second voice signal and outputs the second voice signal from the first headset module of the cell phone.

9. The system according to claim 8, wherein the cell phone further has a hands-free module comprising a microphone unit and a headset unit.

10. The system according to claim 9, wherein the microphone unit of the hands-free module outputs a third voice signal, the voice control module of the cell phone receives the third voice signal and transfers the third voice signal to the earphone, and then the second headset module of the earphone outputs the third voice signal.

11. The system according to claim 9, wherein the second microphone module of the earphone outputs a fourth voice signal, the voice control module of the cell phone receives the fourth voice signal and transfers the fourth voice signal to the cell phone, the voice control module transfers the fourth voice signal to the cell phone, and then the headset unit of the hands-free module outputs the fourth voice signal.

12. The system according to claim 8, wherein the wireless manner is a bluetooth transmission manner, an infrared transmission manner, a wireless network transmission manner or a wireless transmission manner.

13. The system according to claim 8, wherein the cell phone has a communication module, and when the cell phone is chosen to enter a wireless communication mode, the second microphone module of the earphone transfers a fifth voice signal to the cell phone, and then the communication module of the cell phone transfers the fifth voice signal to another cell phone.

14. The system according to claim 8, wherein the cell phone has a communication module for communicating with another cell phone, and when the cell phone is chosen to enter a wireless communication mode, the communication module of the cell phone receives a sixth voice signal from another cell phone and transfers the sixth voice signal to the earphone, and then the second headset module of the earphone outputs the sixth voice signal.
